(19) United States
(12) Patent Application Publication
(10) Pub. No.: US 2009/0017887 A1
(43) Pub. Date: Jan. 15, 2009

(54) Electronic training game and method

(75) Inventor: Laura Montocchio, Apex, NC (US)

Correspondence Address: OLIVE & OLIVE, P.A., 500 MEMORIAL STREET, PO BOX 2049, DURHAM, NC, 27702, US

(73) Assignee: Corporate Training Consultants, Inc

(21) Appl. No.: 12/228,047

(22) Filed: Aug. 11, 2008

Related U.S. Application Data
(63) Continuation-in-part of application No. 11/741,013, filed on Apr. 27, 2007.
Application No. 11/741,013 is a continuation of application No. 11/091,314, filed on Mar. 28, 2005.

(51) Int. Cl. G06F 17/00

(52) U.S. Cl. 463/9; 463/42

(57) ABSTRACT

A computerized game simulating training conversations contains a plurality of Scenarios, each requiring a player to role play a training conversation. The Role Player is judged as to whether he or she demonstrates a specific skill, not identified to the player, while performing the training conversation. When a player successfully demonstrates this “Hidden Skill” his team is permitted to continue play with a new Scenario. A player's turn ends when the player fails to successfully demonstrate the Hidden Skill during the training conversation. By hiding the specific skill from the role player, the game encourages each player to execute a conversation in which he or she performs all necessary training conversation skills. Only then is a player guaranteed to execute the Hidden Skill. The game thereby trains players in all aspects of the relevant conversation skills.

### CROSS-REFERENCE TO RELATED APPLICATIONS

This application is a continuation-in-part of U.S. application Ser. No. 11/741,013, filed Apr. 27, 2007, which is a continuation of U.S. application Ser. No. 11/091,314, filed Mar. 28, 2005.

### BACKGROUND OF THE INVENTION

It is well known in the field of training that the best way to improve a trainee's skills is to role-play a hypothetical conversation between the trainees. However, current known methods lack effectiveness due to the fact that trainees can feel uncomfortable role-playing and lose focus quickly when doing so in a training session. Thus, the trainers and managers who conduct the role playing find themselves wasting precious time trying to keep the trainees focused on the task at hand. So far as is presently known, the prior art has not provided an apparatus or method for training, like that of the present invention, which provides a relaxing and fun game for building skills and confidence, by way of role-playing.

### SUMMARY OF THE INVENTION

This invention teaches a computerized game in which training conversations simulate real-world conversations relating to a specific field. Scenarios provide to the players a particular training conversation that they must role play. During the role play, a player known as the Role Player is judged as to whether he or she demonstrates a specific skill, not revealed to the Role Player, while performing the training conversation. This specific skill is known as the Hidden Skill. Since the Role Player is unaware of the Hidden Skill on which the Role Player is being judged, the Role Player must perform all general conversation skills and other skills relevant to a particular Scenario. This increases the likelihood that the Role Player will successfully demonstrate the Hidden Skill. Successful demonstration of a Hidden Skill ultimately results in a reward or credit being given to the Role Player or the Role Player's team.

One of the players on one of the teams playing the game assumes the role of being the Role Player and another player on an opposing team assumes the role of being the Target Player. A Role Player's objective is to role-play a training conversation with the Target Player based on a Scenario known to all game participants, and in doing so to demonstrate a Hidden Skill, known to those who will judge the Role Player—the judging team—but not to the Role Player himself. The Role Player receives credit for himself and his team upon demonstration of the Hidden Skill during the training role-play. The players in turn act the role of being a Role Player and thus become engaged in playing a game while practicing valuable conversational skills.

One version of the game is generally in the nature of a board game having a board formed with a track with sequential spaces, two or more game pieces for moving along the track according to a player's progress, a random number generator, such as a die, for computing the number of spaces to move the game pieces and a plurality of Scenario cards, each having a Scenario and a Hidden Skill. Selected spaces are labeled in an appropriate way so as to provide either a reward such as “Roll Again” or a penalty such as “Lose A Turn” when the player's game piece lands on a space so labeled.

Another version of the game is generally in the nature of an electronic game having an interface and at least one database that tracks individual or team scores, keeps time, and contains a plurality of “Scenarios” and “Hidden Skills”. The electronic version allows the game to be easily modified for a particular company, industry, or other area of use. An optional administrative interface allows for further modification by trainers, managers, or other instructional designers. The electronic game may be provided in a remote format, allowing simultaneous play in more than one location. In this way, players at remote sites can role play training conversations. Players either communicate using game features such as video chat, or players communicate via telephone or other electronic means.

The players of the game that is the subject of the present invention are commonly sales representatives, but the game is useful in other areas as well. The invention may consist of several different manifestations, including a board game and an electronic game.

Through the use of training conversations, each version of the game is well suited to train game players in the skills necessary to participate effectively in real-world conversations.

### BRIEF DESCRIPTION OF THE DRAWINGS

FIG. 1 is a top plan view of a game board component of the invention showing a track divided into a plurality of sequential spaces extending between a start and a finish end.

FIG. 2 is a perspective view of a die component of the invention.

FIG. 3 is a perspective view of a game piece component of the invention.

FIG. 4 is a diagram of an electronic version of the game.

FIG. 5 is a flow chart of the players of an electronic version of the game.

FIG. 6 is a flow chart of the game setup for an electronic version of the game.

FIG. 7 is a flow chart of the team setup for an electronic version of the game.

FIG. 8 is a flow chart of the start of game play of an electronic version of the game.

FIG. 9 is a flow chart of the training conversation information overview for an electronic version of the game.

FIG. 10 is a flow chart of the role play portion of an electronic version of the game.

FIG. 11 is a flow chart of the judging portion of an electronic version of the game.

FIG. 12 is a flow chart of the players of an electronic version of the game when played remotely by players and teams in different locations.

FIG. 13 is a flow chart of the team setup for an electronic version of the game when played remotely by players and teams in different locations.

### DETAILED DESCRIPTION

### Board Game

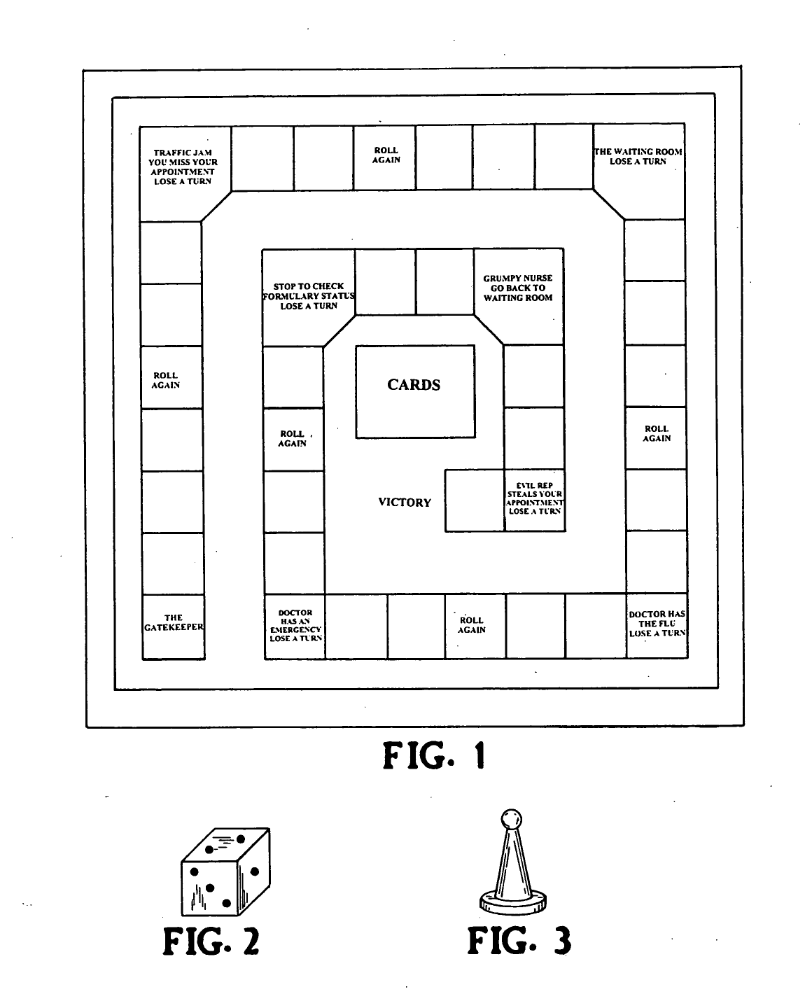

In one embodiment, the game comprises a game board bearing a track, as in FIG. 1, one die, as in FIG. 2, two game pieces, one of which is shown in FIG. 3, a deck of sales Scenario cards, later described, and a timer. In one example of a board game embodiment, the track is divided into a plurality of sequential spaces extending between a start end and a finish end, with the start end being labeled “THE GATEKEEPER” and the finish end being labeled “VICTORY”.

The game board in the embodiment being used by way of example, may be constructed of any suitable material, but preferably comprises a relatively hard material forming a substantially solid surface on which to place the game pieces. As previously mentioned, the game board is formed with a track of sequential spaces selected ones of which are labeled in an appropriate way so as to provide either a reward such as “Roll Again” or a penalty such as “Lose A Turn” when the player's game piece lands on a space so labeled. The game board is preferably decorated in a fanciful manner and with appropriate graphic designs neither of which are shown. While the game pieces may be constructed of any suitable material such as wood, plastic, metal or the like, they preferably are molded of plastic for ease of construction and durability. The terms “game pieces” is used to refer to any device used to mark the location of the player or team's progress along the track. The deck of Scenario cards may consist of any number, but forty is preferred. The cards are preferably decorated and have appropriate graphics on the non-text bearing side. Each card according to a first embodiment will preferably contain the text of a Scenario, a description of a Product or Products, Call Length and a Hidden Skill. In a second embodiment, each card contains only a Scenario and a Hidden Skill. Additionally, the Scenario cards may contain other factors, constraints, or requirements for the player or team to comply with. A toy stethoscope is used to identify the player who assumes the role of a doctor in the role-played sales call and need not be a working stethoscope. All of the components are preferably packaged together in a single container for convenience.

By way of example, the following text may appear on a card:

Scenario: You bump into this Infectious Disease Specialist in the hallway of your hospital. Although he/she is in a hurry, she comments, “I was planning on writing your new antibiotic, but when I looked at the PI, I realized it only works on a few strains of E. Coli . . . ”

### Product(s): XIFAXAN™

Call Length: 1 minute
Hidden Skill Effectively presents the Steffen reprint to discuss spectrum of coverage

By way of another example, the following text may appear on a card:

Scenario: This G.I. doctor has a very busy practice and stays up-to-date on the latest products on the market. He/she enjoys socializing, but rarely gets an opportunity to spend much time with reps because of his/her patient load.

### Product(s): XIFAXAN™, COLAZAL®, AZASAN®

Call Length: 4 minutes
Hidden Skill Engaging opening to COLAZAL® call

By way of another example, the following text may appear on a card:

Scenario: You stop by this gastro's office at the end of a long day. Much to your surprise, he/she is just finishing with the last patient for the day and invites you into his/her office to sit and chat.

### Product(s): XIFAXAN™, COLAZAL®, AZASAN®, ANUSOL®/PROCTOCORT®

Call Length: 6 minutes
Hidden Skill Asks at least two open probes to determine physician's needs/priorities

The manner and rules of play are next described. The number of players is preferably four. However, there may be two, three, five, or more players. For an uneven number of players, for example, three, an individual may play against a team. Prior to beginning play, the Scenario cards are thoroughly shuffled and placed face down on the “Cards” section of the game board to start play. After a card is drawn and used, it is returned to the bottom of the card stack.

Each team chooses a game piece and places it on “The Gatekeeper” space. Each team is provided with at least one copy of mutually approved promotional materials to use while role-playing. On each turn, one player role-plays and acts as a sales representative, and a player on the opposing team role-plays and acts as a doctor.

The team in play decides which of them will be the sales representative during their first turn. The opposing team also determines which of them will assume the role of doctor during their first turn. Whoever is acting as doctor wears a toy stethoscope.

Teammates on each team preferably switch roles on subsequent turns in order that each player in the course of playing one or more games will gain experience both in selling a product as well as in the role of a doctor who is considering the same product. The players, who are not acting as sales representative or doctor on a given turn, silently observe and evaluate the role-play. The focus and length of each role-play is determined by the content of the sales Scenario card a new one of which is drawn on each turn.

As previously mentioned, each sales Scenario card according to a first embodiment contains four categories of information pertinent to each role play: (1) Scenario—describes the selling situation, (2) Product(s)—includes the product(s) the sales representative should include in the role-play, (3) Call Length—time allotted for the sales call, and (4) Hidden Skill—selling skill that must be effectively executed during the role play for a team to advance.

Prior to each role-play, the opposing team reads the information contained in the categories: “Scenario”, “Product(s)” and “Call Length” to the sales representative on the team in play. The opposing team does not reveal the “Hidden Skill” prior to the role-play. The object of each role-play is for the sales representative on the team in play to execute the “Hidden Skill” effectively. Each player when acting in the role of being a sales representative increases his team's chance of advancing by performing a complete, effective sales call on each turn and within the time allotted.

The text of the “Hidden Skill” included on the Scenario sales card being used might, for example, read: Engaging opening, handles doctor's objection, bridges from one product to the next, presents product benefits, asks at least one open probative question to identify the doctor's needs or priorities, uses sales aid or clinical reprint, or asks for a specific commitment from the doctor at the close of a call.

Both game pieces are placed on “The Gatekeeper” space at the beginning of the game. The die is rolled to determine the order of play. The team with the highest roll rolls again and moves that number of spaces. It is essential that they do not reveal the “Hidden Skill” to the role player prior to completion of the role-play.

No additional time is given to prepare for each sales call. It may be assumed that the doctor and sales representative have established a relationship, and that sampling issues do not need to be addressed during the predetermined time.

When the timer beeps, or otherwise signals that a certain period of time has expired, the role-play is over. The opposing team then evaluates the call to assess if the “Hidden Skill” was executed effectively. If the “Hidden Skill” was successfully addressed, the team in play rolls the die and moves the appropriate number of spaces and prepares for their next role-play. The opposing team draws a sales Scenario card and reads aloud only the Scenario, Product(s), and Call Length sections of the drawn card. The opposing team reads the Hidden Skill silently. After listening to the Scenario, the player acting as the sales representative quickly selects the promotional piece or pieces he wishes to use in the sales call. The opposing team then sets the timer according to the predetermined call length (as indicated on the sales Scenario card) and signals the sales representative to begin. Play continues with this player or team, if more than one, until they do not successfully execute the “Hidden Skill” during role-play, or until they land on a “Lose A Turn” space.

The players of the opposing team judge the performance of the player who participated in the role play scenario as the sales representative to determine if that player performed the “Hidden Skill.” If the “Hidden Skill” was not performed, as determined by consensus of the players of the opposing team, the team previously referred to as the opposing team now becomes the team in play, selects a new card, rolls the die, moves that number of spaces, appoints its sales representative, who selects the promotional material he wants to use and proceeds with a role play. At the same time the opposing team appoints its doctor. If a team in play lands on a “Lose A Turn” space, no card is drawn or role-play evaluated for that team, and play continues with the other team. Play is of course assisted when a team in play lands on a “Roll Again” labeled space.

When judging whether a player has executed the “Hidden Skill”, certain aspects are considered. For example, in this embodiment, scoring is all or nothing; the “Hidden Skill” was either executed, or it wasn't. The sales representative may complete a fantastic sales call, but his team does not get to advance unless he has executed the specific “Hidden Skill” specified on the sales Scenario card.

The first team to reach the “VICTORY” space by an exact roll of the die wins the game. Should the outcome of a roll of the die be more than the number of spaces needed to reach the “VICTORY” space, then the team loses its turn.

In a second embodiment, each sales card contains only the Scenario and Hidden Skill. For this second embodiment, the call length timer is set for a predetermined time and the products are constant throughout the game.

In a third embodiment, certain spaces are labeled “Move Back One Space” or “Move Forward One Space” in addition to other text commanding that the game piece be relocated to another space on the track.

In a fourth embodiment, certain spaces are labeled “Doctor's Office” and there are two separate sets of cards. A first set of cards is referred to as “Scenario Cards” and a second set of cards is referred to as “Sales Cards.” Each sales card contains only the products, call length, and Hidden Skill. There is one prewritten Scenario Card for each Doctor's Office space. For each Doctor's Office space, a first Scenario Card governs the role play for the first player to arrive at the first Doctor's Office space. Any subsequent player to arrive at the first Doctor's Office space uses the role play from the player to arrive at that space before them as the scenario for their role play for that space, while drawing a Sales Card for use in the role play. Thus, as those skilled in the art will appreciate and understand, each subsequent player is building off of the experience of the previous player, much in the same way a first sales representative who calls on the same doctor as a second sales representative from the same company as the first would build off of what the first representative was speaking to the doctor about. In the sales field this is known as “Team Selling”. By way of example, in addition to the previously mentioned Hidden Skills, the following Hidden Skill would be appropriate for this embodiment: “Maintains call continuity without redundancy”.

Additional game pieces, a toy stethoscope, additional sales scenario cards or novelty items, and promotional materials may also be added. A spinner or electronic random number operator may be used as a random number generator instead of a die and an hourglass, a mechanical timer, or an electronic timer may be used instead as a timer.

It is also recognized that the illustrated components of the apparatus can be of an electronic form. For example, a computer could be used to present a visual image of the game board, visual images of the game pieces, visual representations of the text of the sales Scenario cards and provide a chance means or an electronic random number generator operator, and a timer.

Also recognized is that use of the game board training of the invention is not limited to the pharmaceutical industry, nor is it limited to sales training. For example, the game board training of the invention can be used in other industries including, but not limited to, electronics, software, appliances, and automobiles. The Scenario cards are thus adapted to include Scenarios and Products appropriate to the industry of the players. Likewise, selected spaces on the game board can be named with names appropriate for the industry of the players. By way of example, “Doctor's Office” could be renamed “Chief Technology Officer's Office” for software sales representatives and other software training.

The board game of the invention in the form represented by the above pharmaceutical sales call example can be summarized as follows:
A board game adapted for simulating with one player of the game the role of being a sales representative making a sales call on a doctor and for simulating with another opposing player of the game the role of a doctor being called on by a sales representative and for utilizing the game play as a means for training the game's players as sales representatives to doctors, comprising:
   (a) a pair of game pieces adapted to be placed on a selected one of a plurality of separate sequential spaces, one of said game pieces corresponding during play of the game to a player of said game acting in the role of a sales representative calling on a doctor and the other of said game pieces corresponding during play of the game to an opposing player of said game acting in the role of a doctor being called on by the sales representative;
   (b) a game board bearing a track divided into a plurality of separate sequential spaces extending between a beginning space and an ending space and having selected of the spaces labeled in such a manner as to either reward or penalize a player landing on such space;
   (c) a random number generator for regulating motion of said game pieces along said track;
   (d) a timer for timing the amount of time allowed for playing one turn of the game;
   (e) a plurality of Scenario cards containing on one side of each card a role play for a sales representative and a hidden skill by which the performance of a sales representative is to be judged; and
   (f) a set of rules making play for each turn dependent on use of said hidden skill and governing play of the game utilizing said game pieces, game board, random number generator, timer and Scenario cards whereby to result in successively training all of the players of said game in sales representation when selling to a doctor.

With the above in mind, an object of the invention is to provide an entertaining way to practice valuable skills, enabling its participants to become more comfortable in performing these skills and consistently executing these skills. Other objects will become apparent as the description proceeds.

### Electronic Game

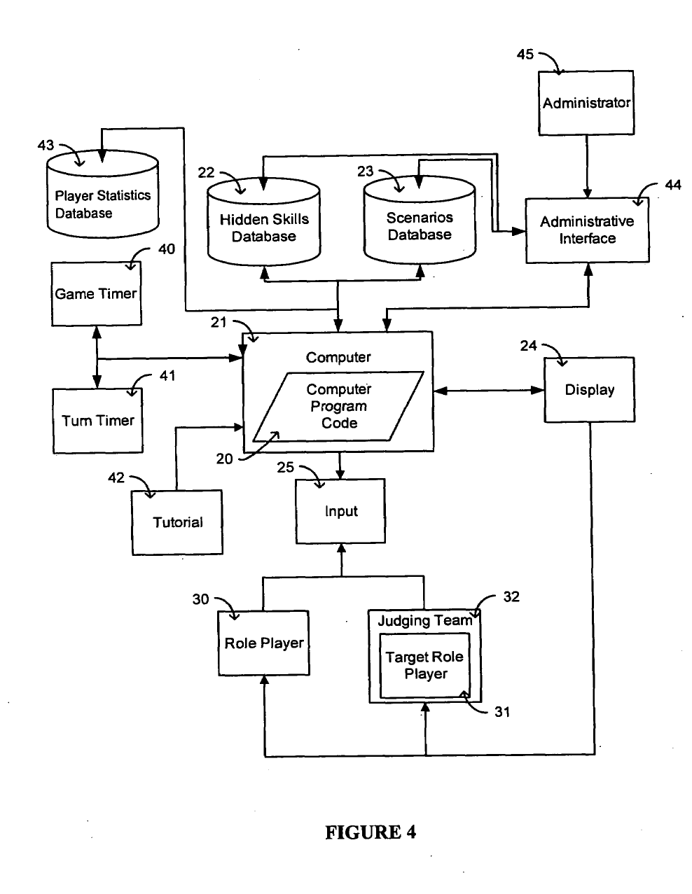

FIG. 4 illustrates another embodiment of the game comprising computer program code 20 for a computer 21, and at least one database, here shown as two databases, a Hidden Skills database 22 and a Scenarios database 23, each of which in this example has a different function as further explained below. The computer program code 20 may be stored on a player's computer 21 or on a computer readable medium or the computer program may be located on a remote computer and accessed by a player through another computer, terminal, or other electronic means. Each computer 21 or similar electronic device should have one or several output methods of displaying game information, such as a monitor, printer, speaker, or other electronic display device. The output methods serve as a display 24 device by which players-here, the Role Player 30, the Target Player 31 and the judging player(s) 32—receive game information. Additionally, each computer should have one or several input methods for receiving user input such as a keyboard, mouse, microphone or other input device. The input 25 serves as the means by which players provide information to the game. The term “computer” includes traditional computers as well as electronic gaming devices, mobile phones, smart terminals, and other electronic systems.

The computer program code 20 facilitates the play of a game in training conversations by a player engaged in a role play through the use of Scenarios, which are stored in a Scenarios database 23. During role play, a Scenario provides to the players a particular training conversation, which can be a “conversation” requiring oral, written and/or visual communication. Each Scenario should preferably be designed to simulate a conversation common to the business within which the trainees work. The training conversations contained in a Scenario may describe specific people, situations, or products to be included in a role play. The Scenario may also contain other factors, constraints, or requirements with which a Role Player or team must comply. The Role Player 30 uses the Scenario as a guide to role play the training conversation. For instance, the Role Player 30, acting as a pharmaceutical sales rep, may receive a Scenario wherein the Role Player 30 must simulate a conversation about the side effects of a new drug with a Target Player 31, who acts as a doctor. Scenarios may be customized for a particular business or industry.

By way of example, the following text may appear as a Scenario in a game directed at training pharmaceutical sales representatives:

Scenario: This physician prides himself on staying current with the latest medical news. During the conversation he states, “I read a study recently that reported patients taking Drug A are at an increased risk for hemorrhagic stroke. That concerns me.”

By way of example, the following text may appear as a Scenario in a game directed at training pharmaceutical sales representatives:

Scenario: You have a scheduled appointment with this busy primary care physician. You know he's used tricyclic antidepressants in the past to treat patients with fibromyalgia.

By way of example, the following text may appear as a Scenario in a game directed at training general sales representatives:

Scenario: During your appointment today with this customer to discuss an impending price increase, he tells you he doesn't know how many more price increases he can take before he considers switching to one of your competitors.

By way of example, the following text may appear as a Scenario in a game directed at training in business conversations:

Scenario: You've spoken with this protege once before, and that conversation did not go well. Neither of you really knew what to say or why you were talking to each other. Today your goal is to gain this protege's respect and convince her of the value of the mentoring program.

By way of example, the following text may appear as a Scenario in a game directed at training in business conversations:

Scenario: This is your star protege. She's been getting rave reviews from her superiors, as well as from the client. Your biggest challenge with her is making sure she continues to learn new skills and is challenged to improve her already stellar performance.

Also contained in the Hidden Skills database 22 are a set of skills, all of which a player is expected to demonstrate through the course of a proper conversation associated with this field. Each of these skills, called Hidden Skills because during the role play they are hidden from the Role Player, may be used with one or more Scenarios, a subset of Scenarios, or all Scenarios depending on applicability. For instance, suppose the databases contain Hidden Skills 1-5 and Scenarios A-E. Hidden Skills 1-3 may be used with all Scenarios A-E and Hidden Skills 4-5 may be used with only Scenarios A, C and E. Upon receiving a Scenario, those judging player(s) 32 who judge the Role Player 30 also receive notification of one specific skill—the Hidden Skill—by which to judge the Role Player 30. Alternatively, the Hidden Skill may consist of two or more of the skills. The Role Player 30 does not know on which skill the Role Player 30 is being judged until after the Role Player 30 finishes the training conversation. Throughout the role play, judging player(s) 32 observe the Role Player 30 to determine whether the Role Player 30 demonstrates the Hidden Skill. Since the Role Player 30 is unaware of the Hidden Skill on which the Role Player 30 is being judged, the Role Player 30 must perform all general conversation skills and other skills relevant to a particular Scenario to ensure successful demonstration of the skill on which the Role Player 30 is being judged. If the Role Player 30 does demonstrate the Hidden Skill, the Role Player 30 receives credit for the demonstration; however, the Role Player 30 receives less or no credit for failure to demonstrate the Hidden Skill.

By way of example, the following text may appear as a Hidden Skill in a game directed at training pharmaceutical sales representatives:

Hidden Skill Effectively use a visual aid or clinical reprint to support message.

By way of example, the following text may appear as a Hidden Skill in a game directed at training pharmaceutical sales representatives:

Hidden Skill Grab physician's attention with an engaging opener.

By way of example, the following text may appear as a Hidden Skill in a game directed at training general sales representatives:

Hidden Skill Address objections.

By way of example, the following text may appear as a Scenario in a game directed at training in business conversations:

Hidden Skill Begin the interaction with social chit-chat to build rapport, then transition to the topic at hand.

By way of example, the following text may appear as a Scenario in a game directed at training in business conversations:

Hidden Skill Gain protégé's commitment to take specific, measurable action steps before your next conversation.

At the time the Hidden Skill is displayed to the judging players 32, the judging players 32 may also receive special instructions as to judging the role player. For instance, a Hidden Skill as in a prior example which states “Address objections” may include the following: “If the Target Player 31 had no objections, Role Player 30 automatically gets credit for executing the Hidden Skill.” These instructions may include criteria on which the judging team determines whether the Role Player 30 demonstrates the Hidden Skill. These instructions may also provide clarification to the judging players 32 on particularities of the Hidden Skill.

It should be noted that the ordinary way to talk about skills is to use language that refers to them as if they were visible tangible objects. Of course, a skill cannot necessarily be seen absent a performance of the skill. Persons of ordinary skill in the art appreciate that where a skill cannot itself be seen, the reference to the skill may be to a representation of the skill that is being presented, in a form sufficient to allow those viewing or hearing the representation to understand the skill that is being referenced. Thus, for example, when one says that a “Hidden Skill” is displayed, a representation of the Hidden Skill may appear on the screen or be heard on a speaker or displayed in other form. Nonexclusive examples of such representations include text, drawings, animations, video clips, sound, audio clips, and live or recorded performances.

Each game begins by selecting a game play method. Alternatively, the play method may be pre-selected by the computer 21 or by a third party or only one game play method may be available. The game can be played in at least two different ways, including: Multi-Player Mode and Single Player Mode. Each game play method allows multiple role play opportunities.

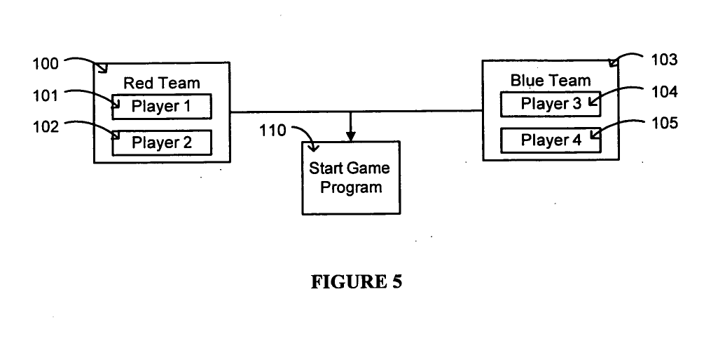

Multi-Player Mode allows at least two teams, each consisting of at least one player, to compete against each other. For example (see FIG. 5), a Red Team 100 may have two players—Player 1101 and Player 2 102—and a Blue Team 103 may have two players-Player 3 104 and Player 4 105. On each turn as depicted in flow chart form in FIG. 4, a player from one team acts as the Role Player 30 and a player from another team acts as the Target Player 31. For instance when it is the Red Team's turn, the Red Team's Player 1101 acts as the Role Player 30 while the Blue Team's Player 4 105 acts as the Target Player 31. On the Red Team's next turn, Player 2 102 acts as the Role Player 30 while the Blue Team's Player 3 104 acts as the Target Player 31. Alternatively, Blue Team's Player 4 105 may act as the Target Player 31. The computer 21 preferably selects the Role Player 30 in Multi-Player Mode, while the judging player(s) 32 select the player to act as the Target Player 31. Optionally, the computer 21 or a third party could select the Target Player 31 and/or the Role Player 30. Multi-Player Mode is well-suited for two teams of two players each; however, larger groups may play together, exposing larger groups of trainees to the role plays of other players. For example, a Green Team may have four players, a Yellow Team may have three players and a Purple Team may have two players.

Individual Play allows one player to play the game against the computer 21. For example, one player may act as the Role Player 30 with the computer 21 acting as the Target Player 31 and judging player(s) 32. Individual Play involves a single player role playing with the computer 21, which may use pre-programmed artificial intelligence to judge the Role Player 30. The computer 21 judges whether the Role Player 30 demonstrates the Hidden Skill. Optionally, Individual Play may allow a team to play against the computer 21.

In another embodiment, players may select the method of turn rotation during game setup. For instance, teams or groups may select to alternate role play between each turn, or a team or group may continue to role play so long as they correctly demonstrate the Hidden Skill. Other methods of turn rotation may exist in other embodiments. Also, the computer 21 may randomly skip the turn of a team or group, introducing an element of chance into the game.

After selecting the game play method, the players may select when they want the game to end. This may be done by entering a total game duration, a specific number of Scenarios to role play, a total number of points for one team to reach, a certain score differential, or some other method. For instance, if a player enters sixty minutes for the total game duration, the game would end 60 minutes after it started; or, a player may specify that the game ends when one team or group correctly demonstrates the Hidden Skill in five Scenario role plays. In another embodiment, the computer 21, an administrator 45, or some other third party may set when the game ends. The game timer 40 tracks the total game duration.

After game setup is complete, the computer 21 displays on the display 24 a list of some or all Hidden Skills that may be utilized during the current game. The list of Hidden Skills is stored in the Hidden Skills database 22. Displaying the list of Hidden Skills informs players of the Hidden Skills on which they may be judged. Since players are judged on their demonstration of Hidden Skills, it may be helpful to remind players of the different skills on which they may be judged. For instance, each of the example Hidden Skills included above may be displayed on the display 24 to the players prior to game play.

Once players configure the game and view the list of Hidden Skills, the game interface appears on the display 24. The game interface may include one or more of the following: a visual game screen, a game duration timer, a turn indicator, a scorer, or a main content area. The game duration timer displays the total remaining time as determined by the game timer 40. The turn indicator indicates which team or group acts as the Role Player. When playing in multi-player mode, this indicator also indicates which player in the team is to act as the Role Player. The scorer indicates how many points each team or group has earned. In one embodiment of the game, the winner is the team or group with the most points. Other embodiments may have other methods for determining a winner, such as percent of correct role plays, point differential, or other methods. The main content area may display one or more of the following: the Scenario, any product information, or the conversation duration, which is tracked by the turn timer 41.

All players are allowed to see, hear, or be otherwise exposed to any content displayed on the display 24 within the game interface, with one exception. That is, the Role Player 30 may not see or otherwise be exposed to the Hidden Skill. Optionally, the Hidden Skill may also be concealed from the other members of the Role Player's team. Within the main content area is a button to reveal the Hidden Skill. The judging player(s) 32 are allowed to view this Hidden Skill, on which the Role Player 30 is to be judged. However, it is imperative for the success of the game that the Role Player 30 does not see this Hidden Skill. To keep the Hidden Skill hidden, the Role Player 30 may be asked to turn away, the screen may be moved out of his line-of-sight, or the Hidden Skill may be displayed separately on another display device visible only to the judging player(s) 32. Once the judging player(s) 32 know the Hidden Skill by which to judge the Role Player 30, the Hidden Skill may be hidden from view.

Once the game has been configured, each player should read the Scenario and gather any accompanying information such as product flyers and other handouts. In addition to appearing on the display 24, Scenarios may be read aloud by a moderator or printed on handouts for players to read. Once the players know the Scenario, the Role Player 30 and Target Player 31 begin simulating the training conversation. When players begin the training conversation, a turn timer 41 tracks the time allotted to each Scenario and displays the remaining turn time or total elapsed turn time on the display 24. These times may be preset or may be assigned randomly by the computer 21. These training conversations may be directed toward a sales person talking with a buyer, a doctor talking with a patient, a lawyer talking with a client, a police officer talking with a suspect, a mentor talking with a protege, a coach talking with a player or team, a manager talking with an employee, a teacher talking with a student or teaching a class, or any other conversation. In the alternative, a Scenario may require a role player to simulate a one-sided training conversation. For instance, the Role Player 30 may act as a presenter or teacher providing information to a group; instead of a two-way conversation between the Role Player and opposing Role Player, the Role Player may be the only one participating in the training conversation role play. The Scenario may involve oral, audiovisual, or electronic conversations.

After the Role Player 30 completes a training conversation, the judging player(s) 32 determine whether the Role Player 30 satisfactorily demonstrated the Hidden Skill. Only after the conversation is completed does the Role Player 30 become aware of the Hidden Skill against which the conversation is evaluated. In one embodiment, if the Role Player 30 does demonstrate the Hidden Skill, the Role Player 30 is given credit, and if the Role Player 30 fails to demonstrate the Hidden Skill, he receives no credit. Another embodiment may allow for partial credit or other reward systems. During the judging, some or all players may participate in discussion of the Role Player's 30 training conversation. This discussion provides additional training for participants. In another embodiment, discussion may include third parties or other observers.

After a training conversation is complete, and after the judging player(s) 32 decide whether the Role Player 30 demonstrated the Hidden Skill, a new Scenario may appear. A new training conversation ensues. Different game play setups may allow a Role Player 30 to continue role playing after completing a training conversation or the turn may switch to a different player. The order of turns may be random or may be determined by a preset order. For example, teams may alternate role play turns to ensure each player has a chance to participate in a role play. The players need not determine the order of the role plays. For example, the computer 21, a game moderator, or a third party may determine the order of turns.

Players or teams continue to role play training conversations until the game is over. A game may end by expiration of some set time as determined in the game setup, by reaching a total number of points, by completing a certain number of training conversations in a row, or by some other method.

The game may also contain an audio or audiovisual tutorial 42. This tutorial 42 may teach players the rules of the game, how to use the game program, and may provide information on the skills necessary to complete a training conversation. Players are encouraged to watch the tutorial 42 in order to better understand how to play the game. The tutorial 42 also shows players the various components of the game program and how to interact with the game. Players may select whether or not to view the tutorial 42 upon starting the game software. Alternatively, some or all players may be required to view the tutorial 42. For example, all new players might be required to view the tutorial.

Optionally, a database 43 may store player statistics. These statistics may include game history, Scenarios completed, time spent training, or other performance indicators. Players or teams may be uniquely identified. For instance, players or teams may be assigned login credentials, including a username and password, which they must enter before beginning each play. The database 43 stores the various game statistics as they relate to each username. For example, the database 43 may store player names, number of games played, a list of Scenarios completed, a list of Hidden Skills tested, a list of Hidden Skills successfully demonstrated and game play win-loss record. These player and team statistics allow managers or supervisors to obtain records and reports from the database 43 including team progress throughout multiple training conversation games. Another embodiment may allow managers or supervisors to use these database 43 records to set certain goals for players or teams. For instance, a manager may require that each player or team needs to demonstrate the Hidden Skill in four out of every five game plays to receive a quarterly bonus. Or for instance, a teacher may assign grades based on demonstration of the Hidden Skill.

In yet another embodiment of the game, an administrative interface 44 allows one or more administrator 45 to access game setup features, player usage statistics, and other pertinent game information. Multiple administrative access levels can exist. For instance, a basic administrator may be able to view all player statistics, but may not be able to alter any other game setup features or player usage statistics; a regular administrator may be able to set individual player or team training goals such as number of Scenarios to complete each quarter, but not be able to change game setup features; and an advanced administrator may be able to alter all game setup features, including Scenarios, Hidden Skills, and training conversation durations, and may be able to alter other pertinent game information. Each administrative access level may be a subset of another, more advanced administrative access level, or it may provide for an independent level of access. Other administrative access levels may be available. With the appropriate administrative access level, an administrator can log into the game databases, Hidden Skills database 22 and scenarios database 23 and alter Scenarios, product information, training conversation durations, and Hidden Skills. In this way, the game may be implemented in a number of different business environments. An administrator 45, using the administrative interface 44, may add Scenarios specific to a particular company or occupation and may also edit or delete existing Scenarios. The administrator 45, using the administrative interface 44, may alter product information as new products become available or as existing products change. The administrator may also set different training conversation durations. Finally, the administrator 45, using the administrative interface 44, may edit the database containing the set of Hidden Skills. For example, existing Hidden Skills may be altered in some way, or deleted, or new Hidden Skills may be added. Many Hidden Skills may be common across various training environments, such as “makes eye contact” or “closes sale”. However, some may be specific to a particular occupation or company. Additional functionality may be included within the administrative interface 44 to allow for further customizations and control. The administrative interface 44 allows various administrative access levels in order to make changes necessary to customize the game for a particular deployment.

### EXAMPLE 1

### Electronic Game

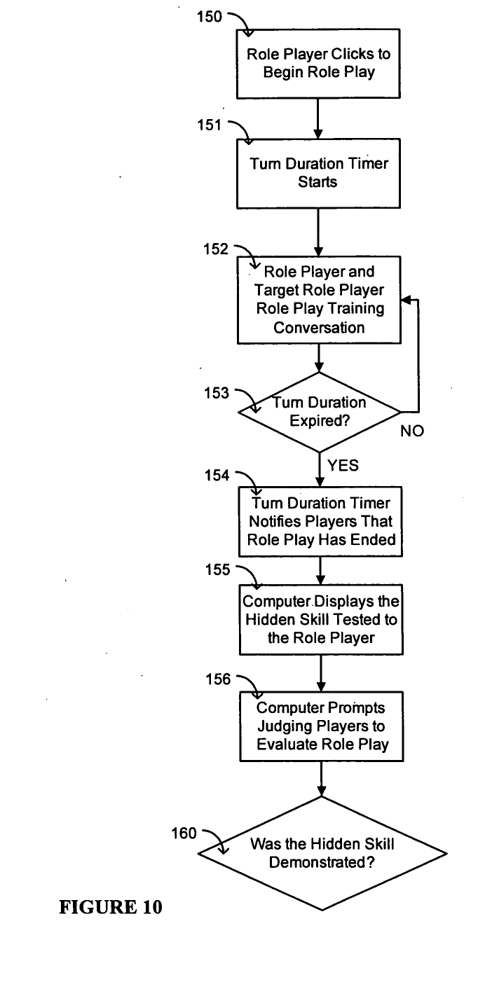

Together, FIGS. 5 through 11 provide an example of one embodiment of an electronic version of the game. For this example, at FIG. 5, two teams-Red Team 100 and Blue Team 103—will have two players each—Players 1 101 and Player 2 102 on the Red Team 100 and Player 3 104 and Player 4 105 on the Blue Team 103 (collectively, “the Players”). The Players are all in the same location, playing the game together on one computer. In this example, the Players work for a pharmaceutical company as pharmaceutical sales representatives. The Scenarios pertain to situations common to a pharmaceutical sales representative having a conversation with a doctor. The goal of this example of the game is to train pharmaceutical sales representatives to promote and sell pharmaceutical products to doctors. To begin with, the Players start the game program (step 110) on a computer.

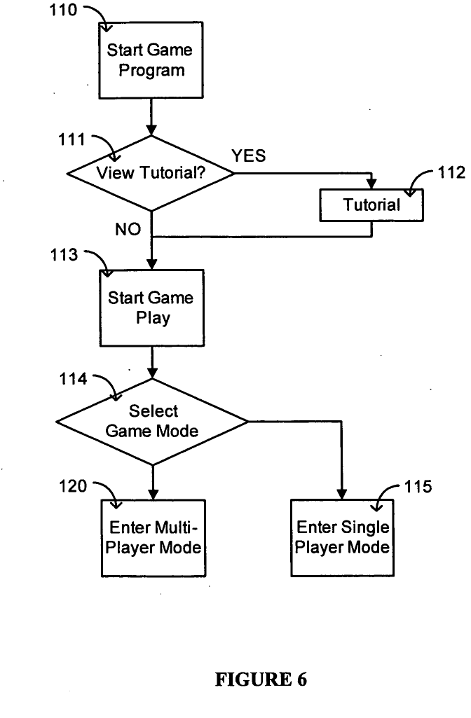

As shown in FIG. 6, once the Players start the game program (step 110), they have the option (step 111) to view a “How to Play” audiovisual tutorial (step 112). Viewing the tutorial (step 112) is highly recommended for first-time players. The players also have the option (step 111) to skip viewing the tutorial. After viewing the tutorial (step 112) or after electing to skip the tutorial and begin game play, the Players instruct the computer to start the game by selecting the appropriate icon with an input device (step 113). The Players may select Multi-Player Mode (step 120) or may select Single Player Mode (step 115). Since, in this example, the Players are made up of two teams of two individuals each, they select Multi-Player Mode (step 120).

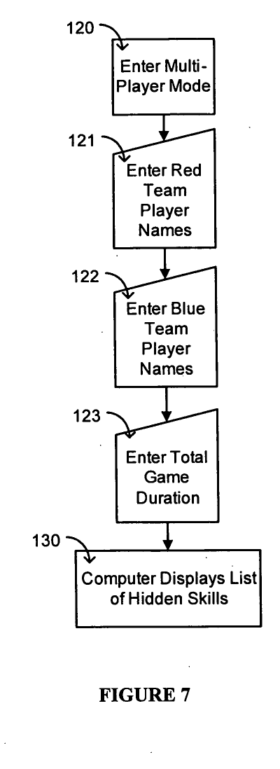

As shown in FIG. 7, after entering Multi-Player Mode (step 120), the computer prompts the Red Team 100 to enter its players' names (step 121). The Red Team 100 enters the names of Player 1 101 and Player 2 102 into the appropriate fields (step 121). Next, the computer prompts the Blue Team 103 to enter its players' names (step 122). The Blue Team 103 enters the names of Player 3 104 and Player 4 105 into the appropriate fields (step 122). At step 123, the Players select a total game duration in minutes—here, 60 minutes. Game setup is now complete. The computer then preferably displays the list of Hidden Skills relevant to the game (step 130). The Players may access the Hidden Skills via a menu, or, preferably, the computer may display the skills without player interaction. This ensures that the Players are aware of the different Hidden Skills on which they may be evaluated during game play. However, the Players may be required to rely on their memory of all relevant skills rather than be reminded of them before beginning play. Once game setup is complete, and any desired review of Hidden Skills has been conducted, the Players are ready to begin game play.

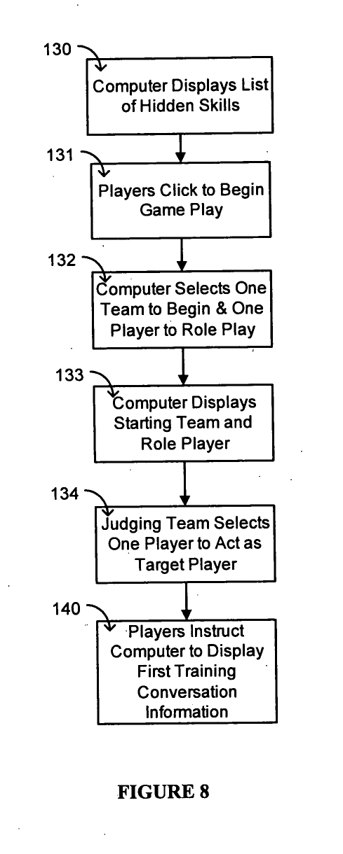

As FIG. 8 illustrates, after the computer displays the list of Hidden Skills relevant to the game (step 130), the Players instruct the computer to start game play by selecting the appropriate icon with the input device (step 131). Once the Players are ready, the computer randomly selects one team to begin play and designates one player from that team to be the initial Role Player (step 132). The computer then displays this information to the Players (step 133). In this example, the Blue Team 103 is selected to begin, and Player 3 104 is designated as the Role Player. Since the computer selected the Blue Team 103 to role play first, the Red Team 100 must select a member of its team to act as the Target Player (step 134). In this example, the Red Team 100 selects Player 1101 to act as the Target Player (step 134). Players are now ready to receive the first training conversation information (step 140).

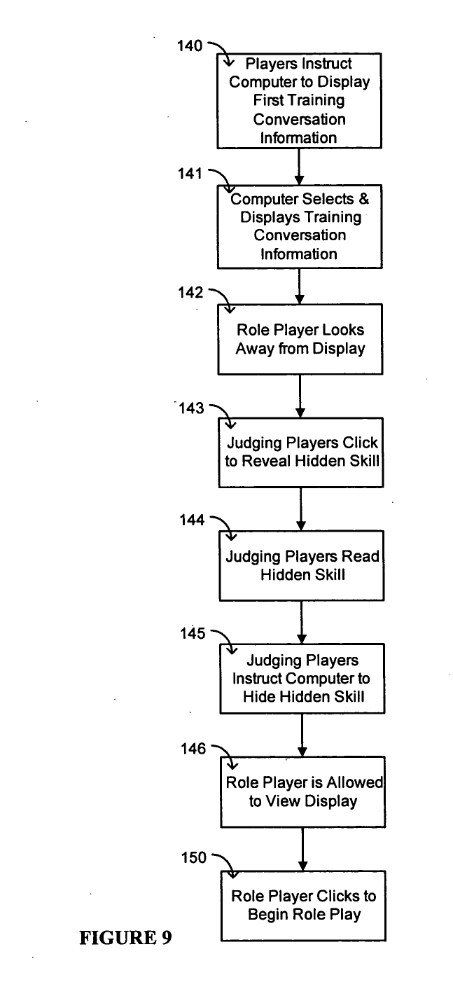

In FIG. 9, once the Players are ready and instruct the computer to display the first training conversation information by clicking the appropriate icon with the input device (step 140), the computer selects and displays the first training conversation information, including a Scenario and turn duration (step 141). The computer randomly selects the Scenario from the Scenario database. The Scenario -himself on staying current with the latest medical news. During the conversation he states, ‘I read a study recently that reported patients taking Drug A are at an increased risk for hemorrhagic stroke. That concerns me.”’ The turn duration displayed is randomly selected by the computer, within preset parameters; however, optionally the turn duration may be preset such that each Scenario has a specific turn duration; however, optionally the computer may select the turn duration at random or the Players may set the turn duration. The turn duration is the time during which the Players must complete the training conversation; in this case, the turn duration is 4 minutes. Before the role play begins, the team opposing the Role Player—the judging team—is permitted to view the Hidden Skill (which typically is a single skill but alternatively may be two or more skills). However, the Role Player (Player 3 104) may not view the Hidden Skill until after the training conversation is complete. To ensure the Role Player (Player 3 104) does not see the Hidden Skill, the judging team may ask the Role Player (Player 3 104) to turn away or move out of the view of the computer display (step 142); the judging player(s) 32 may also hide the display from the Role Player's (Player 3 104) view by moving or otherwise concealing the display. To view the Hidden Skill, the judging team instructs the computer to reveal the Hidden Skill by clicking the appropriate icon with the input device (step 143). For this example, the judging team—the Red Team 100—is permitted to view the Hidden Skill. In this example, the Hidden Skill states: “Effectively use a visual aid or clinical reprint to support message.” The judging player(s) 32 read the Hidden Skill silently (step 144) and instruct the computer to hide the Hidden Skill from the Role Player's (Player 3 104) view by clicking the appropriate icon with the input device (step 145). After hiding the Hidden Skill, the Role Player may once again view the display (step 146), and the Role Player (Player 3 104) instructs the computer to begin the role play by clicking the appropriate icon with the input device (step 150).

The display, as earlier noted, need not be a visual display. For example, the Hidden Skill may preferably be displayed in an auditory manner by a display that is a speaker when the skill itself relates to oral proficiency, or if the players are unable to see. Alternatively, it could be displayed in an audiovisual format. Persons skilled in the art will immediately appreciate how to display the Hidden Skill in these and other formats in accordance with the steps described herein.

Once the Role Player (Player 3 104) instructs the computer to begin the role play (step 150), the turn duration timer starts (step 151). The Role Player (Player 3 104) and the Target Player (Player 1 101)—one of the members of the Red Team 100—begin role playing the training conversation based on the Scenario (step 152). The Role Player (Player 3 104) and the Target Player (Player 1 101) each assume the customary roles of a pharmaceutical sales representative and a doctor respectively and have a conversation appropriate to the Scenario. Throughout the role play, the Players, aside from the Role Player (Player 3 104), should observe the Role Player's (Player 3 104) dialogue and conduct for demonstration of the Hidden Skill. Since the Role Player (Player 3 104) does not know the Hidden Skill, the Role Player (Player 3 104) must demonstrate all skills that normally should be executed during a conversation of this nature. While the players role play, a turn duration timer monitors the turn duration remaining (step 153). When time expires, the turn duration timer displays on the display that the role play has ended (step 154). Optionally, role play can be stopped manually if the Role Player (Player 3 104) completes his conversation before time expires. After the training conversation is complete, the computer informs the Role Player (Player 3 104) of the Hidden Skill tested by displaying (step 155). After informing the Role Player (Player 3 104) of the Hidden Skill, the computer preferably prompts the Red Team 100 to judge the Role Player (Player 3 104) on whether the Hidden Skill was demonstrated (step 160).

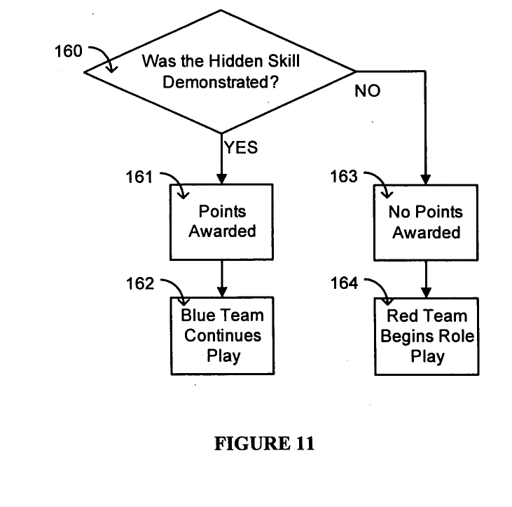

As shown in FIG. 11, the judging team—here, the Red Team 100—preferably judges the Role Player (Player 3 104) as to whether the Role Player (Player 3 104) successfully demonstrated the Hidden Skill during the role play (step 160). The judging portion of the role play is important to the training purpose of the game. The Players may openly discuss the training conversation and the Role Player's (Player 3 104) dialogue and conduct. Once the Red Team 100 decides whether or not the Role Player (Player 3 104) demonstrated the Hidden Skill, the Red Team 100 instructs the computer as to whether the Role Player's team—here, the Blue Team 103—should receive credit. If the Role Player (Player 3 104) did successfully demonstrate the conversation, the Blue Team 103 will be awarded points (step 161) and may continue with the next role play (step 162); otherwise, the Blue Team 103 receives no points (step 163) and loses the turn to the Red Team 100 (step 164). Other versions of the game may allow for different reward systems and turn selection.

At the completion of the role play, the computer randomly selects another Role Player from the Red Team or Blue Team and randomly selects a new Scenario for role play. The process of role playing training conversations repeats until the allotted game time expires. Optionally, the Players each take turns acting as the Role Player. The computer may randomly choose for one team to “lose a turn,” helping to ensure that each player has a chance to act as the Role Player. Upon the expiration of the 60-minute total game time, the team with the most points is declared the winner. In the event each team has an equal number of points, the computer selects a winner at random.

### EXAMPLE 2

### Remote Electronic Game

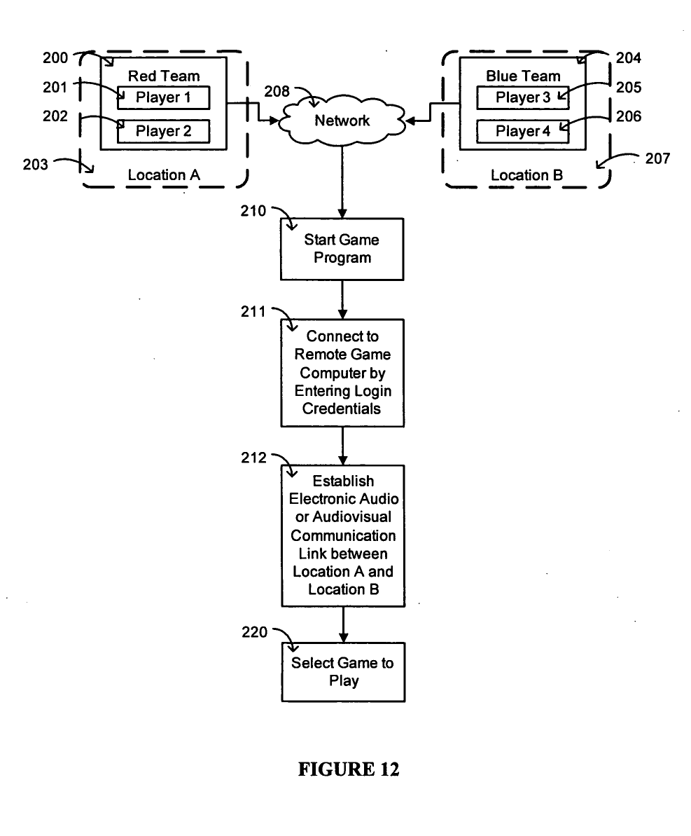

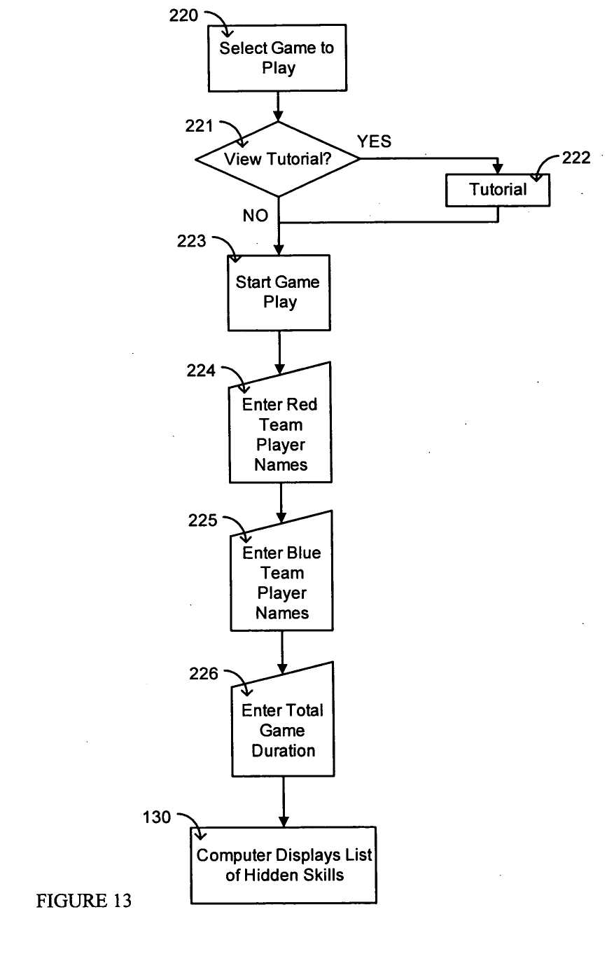

FIGS. 12 and 13 provide an example of one embodiment of a remote electronic version of the game. In this example, FIG. 12 shows two teams—Red Team 200 and Blue Team 204—each having two players-Player 1 201 and Player 2 202 on the Red Team 200 and Player 3 205 and Player 4 206 on the Blue Team 204 (collectively, “the Players”). In this example the Red Team 200 is in Location A 203 and the Blue Team is in Location B 207. These two locations, location A 203 and location B 207 can be as near as separate computers in the same room or as far as across the world. Alternatively, Player 1 201 and Player 2 202 could be in different locations from each other; similarly, Player 3 205 and Player 4 206 could be in different locations from each other. A network 208, such as the Internet, connects the locations electronically to the game. The game comprising computer program code for a computer and at least one database is stored on a server computer accessible by both teams and contains all instructions and data needed for playing the game. In one version of the game, the Players may connect to the game through an Internet connection to an online version of the game using a secure Internet address. In another embodiment, the game or components thereof could be stored on one or more computers operated by the players or third parties and could communicate over a network without the need for a server computer. In this example, the Players act as mentors working with protégés. The Scenarios pertain to situations common to mentors having a conversation with a protégé. The goal of the game is to train mentors to communicate efficiently and effectively with their protégés.

As illustrated in FIG. 12, to begin, the Players start the game program (step 210) on their individual computers—one computer at Location A 203 and one computer at Location B 207. The Players connect to a remote game computer by entering login credentials, including a username and a password (step 211). A moderator or administrator may provide these login credentials, or optionally, players may register for the game and receive login credentials electronically. Once each Player is connected to the remote game computer, an appropriate communication link, typically electronic, between location A and location B is established (step 212) and the Players select the game to play (step 220).

After the Red Team 200 chooses to play a game against the Blue Team 204 and vice versa in FIG. 13 (step 220), the Players have the option (step 221) either to begin game play or to view a “How to Play” audiovisual tutorial 222. The tutorial is highly recommended for first-time players. After viewing the tutorial 222 or after electing to skip the tutorial and begin game play, the players start game play (step 223). The Red Team 200 enters the names of Player 1 201 and Player 2 202 into the appropriate fields (step 224); the Blue Team 204 enters the names of Player 3 205 and Player 4 206 (step 225). Next, the Players select a total game duration in minutes—here, 60 minutes (step 226). Game setup is now complete. The computer then displays a list of Hidden Skills relevant to the game (step 130).

After the computer displays the relevant Hidden Skills (step 130), game play proceeds in the same way as described above and as illustrated in FIGS. 8 through 13. Optionally, each teams' progress, including individual player statistics, are stored in a database. The Players may decide to suspend play and resume at a later time. The game will be saved in a database such that the Players may later begin at the prior stopping point. Additionally, administrative users may use the optional administrative interface to track player and team statistics. This allows a manager to determine which trainees are most or least successful at demonstrating the Hidden Skills.

While the invention has been described with regards to specific embodiments, those skilled in the art will recognize that changes can be made in form and detail without departing from the spirit and scope of the invention. This invention is limited only insofar as it is defined by the following claims and includes within its scope all equivalents thereof.

What is claimed is:

1. A game adapted for simulating training conversations, comprising:
a) a set of instructions, stored on a computer;
b) a database containing a set of scenarios of a role play, stored on a computer;
c) a database containing a set of hidden skills, stored on a computer;
d) a display for displaying one or more selected hidden skills selected from the set of hidden skills;
e) a display for displaying a selected scenario selected from the set of scenarios; and
f) a set of rules making play for each turn dependent on one role player completing a training conversation with another game participant or a first third party and said role player successfully demonstrating one or more selected hidden skills, as judged by players of an opposing team or a second third party, the one or more selected hidden skills being revealed to at least one of said players of an opposing team or a second third party before the beginning of a training conversation, but hidden from said role player at least until after said role player completes said training conversation.

2. A game according to claim 1, wherein said selected scenario further comprises one or more products or services.

3. A game according to claim 1, wherein said selected scenario further comprises a turn duration for the role play scenario, said turn duration comprising a predetermined time during which a player must successfully demonstrate said selected hidden skill in order to continue play for the present turn.

4. A game according to claim 3, wherein a timer tracks said turn duration.

5. A game according to claim 1, wherein said role player continues play until such time as said role player fails to correctly demonstrate said selected hidden skill.

6. A game according to claim 1, wherein the game ends in accordance with said set of rules.

7. A game according to claim 1, wherein said computer randomly skips a player's turn.

8. A game according to claim 1, wherein said computer randomly selects which player, team or group will have the first turn.

9. A game according to claim 1, wherein an administrative interface is used to alter one or more of said databases.

10. A game according to claim 1, wherein a tutorial informs said players how to play the game.

11. A game according to claim 1, wherein game players set a time allowed for playing the entire game.

12. A game according to claim 1, wherein a user accesses said game through a network connection to a server or servers containing said set of instructions.

13. A game according to claim 12, wherein said network consists of the Internet or an intranet.

14. A game according to claim 1, wherein player or team scores are tracked, and wherein a database, stored on a computer, stores said scores.

15. A game according to claim 1, wherein a database, stored on a computer, contains user or team login credentials.

16. A game according to claim 1, wherein players connect to said computer and said database from remote locations.

17. A game according to claim 1, wherein a player or players play the game remotely and communicate by electronic means.

18. A game according to claim 1, wherein said computer displays the set of hidden skills prior to game play.

19. A game according to claim 1, wherein one or more players play against a computer.

20. A game according to claim 19, wherein said one or more players interact with said computer and said computer judges said one or more player's role play.

21. A game according to claim 1, further comprising a scorer for keeping player or team scores.
